(19) United States
(12) Patent Application Publication
(10) Pub. No.: US 2017/0178270 A1
(43) Pub. Date: Jun. 22, 2017

(54) COLLATERAL GENERATION SYSTEM FOR DIRECT MAIL

(71) Applicant: Pebblepost, Inc., New York, NY (US)

(72) Inventors: Lewis Gersh, New York, NY (US); Robert Victor, New York, NY (US)

(21) Appl. No.: 15/382,086

(22) Filed: Dec. 16, 2016

Related U.S. Application Data
(60) Provisional application No. 62/269,885, filed on Dec. 18, 2015.

(51) Int. Cl. G06Q 90/00; G06Q 30/02

(52) U.S. Cl. CPC G06Q 90/00; G06Q 30/0255

(57) ABSTRACT

A collateral generation system generates customized physical collateral on a large scale. Physical collateral can be dynamically generated from creative elements and offers selected based on periodically collected (e.g. daily) information on user interactions with marketers or other entities, marketer rules or campaign goals, or determined insights about the recipient. A collateral generation system can also select and verify a mailing address for intended recipients of physical collateral, and in some implementations, select a printer for a specific piece of physical collateral based on location or other factors.

### CROSS REFERENCE

This application claims a benefit of U.S. Patent Application No. 62/269,885, filed Dec. 18, 2015, the content of which is incorporated by reference it its entirety.

### TECHNICAL FIELD

This disclosure relates to the field of automated collateral generation and transmission.

### BACKGROUND

This disclosure generally relates to generating and sending personalized direct mail. A typical process for sending direct mail to a multitude of recipients takes up to 24 weeks and will generally deliver the same piece of mail to each recipient of the direct mail. The direct mail is completely designed well in advance of mailing including any creative elements as well as any associated offers or promotions, and is intended to be generic or common to each future recipient of the direct mail. Addresses of direct mail recipients are stored in a mailing list and can be added to preprinted direct mail items. Currently, traditional direct mail systems separate the printing and addressing of direct mail into two distinct processes, often performed at two different vendors. First, generic templates of the direct mail are printed without addresses or other personalized information. Next, addresses and fixed personalized details, such as unique promotional codes or names, are added to the already printed templates and subsequently sent for mailing.

Traditional direct mail systems normally print direct mail at one location, as the mailing list used to address the direct mail is generally not usefully sorted to split printing between multiple printers. Consequently, it is difficult to send direct mail to only a relevant subset of a mailing list. After mailing, there is little tracking of sent direct mail and statistics of reception or response rate can have limited accuracy as a result. Existing direct mailing systems are slow and inflexible, both in terms of content and in the selection of recipients to receive direct mail. Bulk mailings are impractical due to inability to match up addressees to specific collateral in a quick and efficient manner.

### BRIEF DESCRIPTION OF THE DRAWINGS

FIG. 1 is a block diagram illustrating an example environment in which a collateral generation system operates, according to one embodiment.

FIG. 2 is a block diagram illustrating an example collateral generation system, according to one embodiment.

FIG. 3 is a block diagram illustrating an example campaign management module, according to one embodiment.

FIG. 4A is a block diagram illustrating an example collateral creation module, according to one embodiment.

FIG. 4B illustrates an example physical collateral item associated with an example marketer, according to one embodiment.

FIG. 4C illustrates an example physical collateral item associated with multiple marketers, according to one embodiment.

FIG. 5A illustrates an example user profile, according to one implementation.

FIG. 5B illustrates an example address graph, according to one embodiment.

FIG. 6 illustrates an example user interface for defining a campaign, according to one implementation.

FIG. 7 illustrates an example user interface for defining collateral objectives, according to one implementation.

FIG. 8 illustrates an example user interface for associating creative elements with a collateral objective, according to one implementation.

FIG. 9 illustrates an example user interface displaying analysis results of a marketing campaign.

FIG. 10 illustrates an example process for generating and mailing specific physical collateral, according to one embodiment.

FIG. 11 illustrates a second example process for generating and mailing specific physical collateral, according to one embodiment.

FIG. 12 illustrates an example process for generating and tracking physical collateral, according to one embodiment.

FIG. 13 illustrates an example process of a physical collateral marketplace, according to one embodiment.

FIG. 14 illustrates an example process for generating a physical collateral item associated with multiple marketers, according to one embodiment.

### DETAILED DESCRIPTION

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

### Configuration Overview

In some embodiments, a collateral generation system generates and sends physical direct mail to a specific user based on information about the specific user and information determined by the collateral generation system to be of interest to the specific user. Additionally, the collateral generation system can receive and analyze feedback on the physical collateral's delivery and reception. Physical direct mail (hereinafter, physical collateral) can be a card, mailer, catalog, letter, envelope, or package, or other physical object sent, often via a mail and/or courier service (e.g. the United States Postal Service, FEDERAL EXPRESS, UNITED PARCEL SERVICE), to a physical mailing address of a user (hereinafter a “mailing”). Each physical collateral item can be associated with one or more marketers representing the source of the mailing and a collateral objective describing the subject or intended effect of the mailing. In some embodiments, collateral objectives are products, services, ad campaigns, or promotional offers determined to be of interest to the user, with the intended effect to inform or remind the user about the product, service, or offer. However, a collateral objective can be any suitable reason for sending physical collateral to a user. Additionally, a physical collateral item can be associated with an incentive such as a discount or promotion code. Each physical collateral item can be personalized or customized to reflect both an associated user and collateral objective. For example, a personalized physical collateral item can be a postcard sent to the mailing address of a user. In this example, the postcard can depict an image of a product previously viewed by but not purchased by the user and include a promotional code for free shipping on the product. Physical collateral items can be associated with a marketer responsible for the content of the physical collateral such as an online retailer or other entity. In some implementations, a single physical collateral item can be associated with multiple marketers, for example a catalog or postcard featuring products offered at multiple different retailers. In implementations utilizing physical collateral mailings associated with multiple marketers, one marketer can be the primary marketer for the physical collateral item and other marketers can be referred to as secondary marketers.

The specific layout and content of a physical collateral item can be described in a plan or representation (hereinafter a “physical collateral plan”) from which the physical collateral can be generated, for example by a large scale printer able to generate bulk quantities of physical collateral at high speeds. In some implementations, a physical collateral plan is a file such as a Portable Document File (PDF) fully describing the physical collateral and including addressing and tracking information. In other implementations, a physical collateral plan can comprise a group of files that fully describe the physical collateral, for example, a PDF template and a text file containing content of fields within the template. In some implementations, one physical collateral plan contains details on many different physical collateral items, or multiple physical collateral plans can be combined to form a larger physical collateral plan associated with multiple physical collateral items.

In some embodiments, physical collateral items may include elements or features facilitating interaction with a computer, such as a printed quick response (QR) code or embedded radio frequency identification (RFID) tag. Physical collateral items may also interface with a computer by means of electrically activated paper, or electrically active elements printed in the paper on which the physical collateral item is printed.

### Example Environment

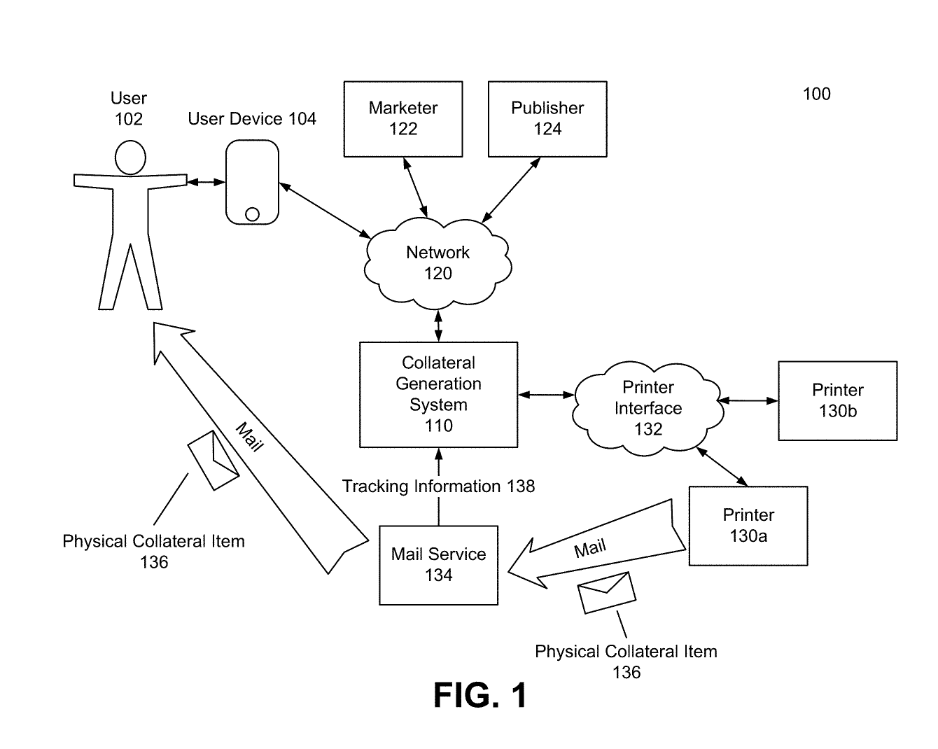

FIG. 1 is a block diagram illustrating an example environment in which a collateral generation system operates, according to one embodiment. The environment 100 of FIG. 1 includes a user 102, user device 104, collateral generation system 110, network 120, marketer 122, publisher 124, printers 130a and 130b, printer interface 132, mail service 134, and a physical collateral item 136. For clarity, FIG. 1 shows only one user 102, user device 104, marketer 122, publisher 124, and mail service 134, and only two printers 130. However, embodiments can include any number of users 102, user devices 104, marketers 122, publishers 124, and printers 130. In addition, it is noted that the marketer 122, publishers 124 and printers 130 may correspond to computing devices (e.g., servers, web sites, communication software) associated with those entities and that interoperate with the example environment.

A user 102 may be an individual having an online account. The user 102 may interact with marketers 122, publishers 124, and the collateral generation system 110. A user 102 can communicate over a network 120, through a user device 104, through an online account, directly, or in any suitable combination. Users 102 also may be associated with a mailing address and receive physical collateral 136 from a mail service 134. A user device 104 can be a mobile phone, smart phone, laptop or desktop computer, tablet, or any other computing device that a user 102 can use to interface electronically with web servers or systems associated with marketers 122, publishers 124, and/or a collateral generation system 110.

It is noted that the user devices, as well as other devices described herein (e.g., marketer or publisher devices, or the collateral generation system 110) include computing components such at least one processor (and/or controller), a memory, a network interface, and a storage. These devices include operating systems that are stored in memory and/or storage and used with computer programs comprised of instructions (also stored in memory and/or storage) and executable by the processor. By way of example, the memory may be a temporary memory (e.g., random access memory). The storage may be a non-transitory storage device (e.g., a flash memory, magnetic disk). The instructions (e.g., program code or software) stored in the memory and/or storage, which are executable by the processor, may correspond to the modules and/or processes described herein. By way of example, the modules may be program code configured to have the processor perform particular functionality as described. Also by way of example, the processes may correspond to steps executed by the processor to enable a particular output.

Referring back to the user device 104, it may be connected to the marketers 122, publishers 124, or collateral generation system 110 over the network 120, and may be associated with a specific user or users 102. Users 102 can interact over a user device 104 using an online account. User devices 104 can each be associated with a device ID that may uniquely identify the device and information originating from the device. In some implementations, user devices 104 are able to collect user activity data when a user interacts with a marketer 122 or publisher 124. Collected user activity data can be transmitted the collateral generation system 110. For example, a cookie or JavaScript code embedded on a website of a marketer 122 can transmit user browsing information or other user activity information from a user device 104 to the collateral generation system 110.

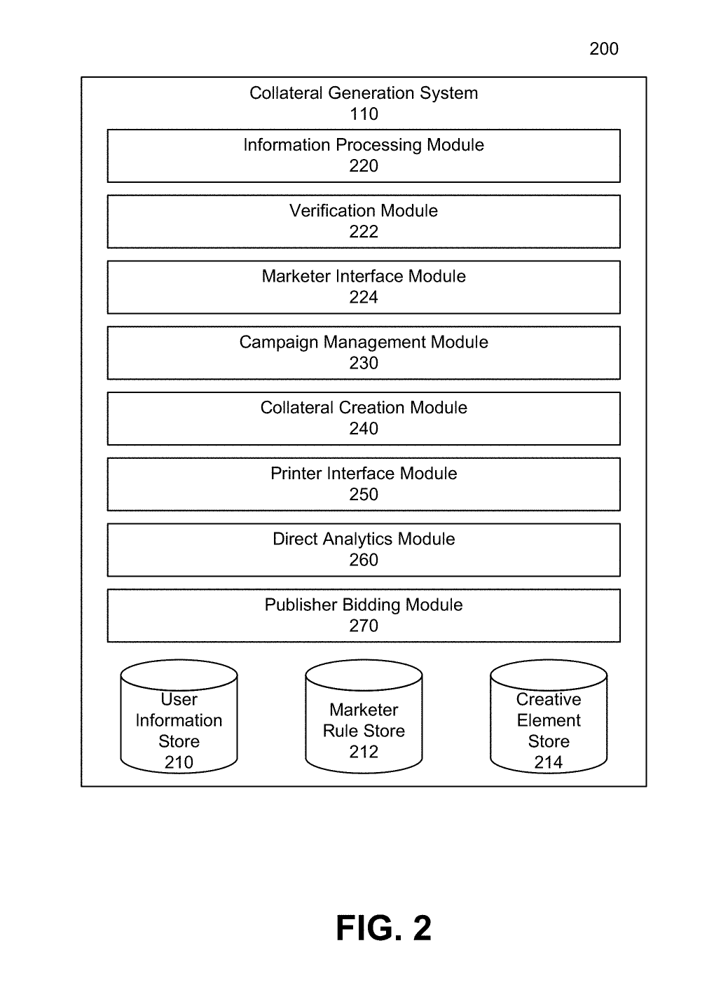

The collateral generation system 110 may generate physical collateral plans based on received information, according to the embodiment of FIG. 1. The collateral generation system 110 can receive information from any number of users 102, marketers 122, and publishers 124. Using this information, the collateral generation system 110 may determine appropriate physical collateral plans to be sent to a printer 130. For example, the collateral generation system 110 may determine appropriate users and content for physical collateral items. The collateral generation system 110 also may receive tracking information about previously sent physical collateral from a mail service or services 134. The collateral generation system 110 will be described in greater detail below and in relation to FIG. 2.

A network 120 may have any combination of local area and wide area networks and can be wired, wireless, or a combination of wired and wireless networks. For example, a network 120 may use standard communication protocols, for example hypertext transport protocol (HTTP) or transmission control protocol/Internet protocol (TCP/IP) over technologies such as Ethernet, 4G, or a digital subscriber line (DSL). In some implementations, data transmitted over the network 120 can be encrypted.

A marketer 122, in the embodiment of FIG. 1, may be an entity or organization that communicates with users 102. Marketers 122 may use or maintain a web server or other system to interact with users 102 electronically, for example through a user device 104. Interactions between users 102 and marketers 122 may correspond to interactions between an online account associated with the user 102 and the online system of the marketer 122. In some embodiments, a marketer 122 may be associated with a set of collateral objectives such as products, services, events, promotional offers, notices, or other information potentially of interest to a user 102. Retailers, online retailers, service providers and websites are all examples of marketers 122. A marketer 122 may provide the collateral generation system 110 with information about users 102, creative elements to incorporate into physical collateral, and desired collateral objectives. For example, a marketer 122 may provide the collateral generation system 110 with information about user interactions with the marketer 122, such as user shipping addresses from past purchases with the marketer 122, user browsing information, or user demographic information. Marketers 122 also may provide product photos and other graphics and a list of products or offers selected as collateral objectives to the collateral generation system 110. Additionally, a marketer 122 may set overall goals (for example, “campaign goals”) for physical collateral mailings in the collateral generation system 110, e.g., as part of a larger marketing campaign. For example, a marketer 122 may set a quota or target for total mailings, mailings with a certain collateral objective, responses, conversions, or any other suitable goal. In some embodiments, the marketer 122 receives information or analysis about generated physical collateral from the collateral generation system 110, such as analysis information on completed physical collateral mailings.

According to the example embodiment of FIG. 1, a publisher 124 is an entity or organization that can communicate with users 102 and marketers 122. Publishers 124 may use or maintain a web server or other system to interact with users 102 and marketers 124 electronically. Interactions between users 102 and publishers 124 may correspond to interactions between an online account associated with the user 102 and the online system of the publisher 124. Similarly, interactions between publishers 124 and marketers 122 may correspond to an interaction between their corresponding web servers or systems. News sources, magazines, and other online content sources are examples of potential publishers 124. Similar to a marketer 122, user activity data may be provided from a publisher 124 to the collateral generation system 110. A publisher 124 may be associated with one or more marketers 122, and user activity information received from a publisher can be used to generate physical collateral or select collateral objectives for an associated marketer 122. In some implementations, physical collateral items generated based on user activity data received from a publisher 124 include an indication of the associated publisher 124 such as a logo or name of the publisher 124. For example, a tent manufacturer (a marketer 122) may be associated with a camping news website (a publisher 124). In one implementation, if a user 102 viewed an article on tents on the camping news website that user activity data can be used to generate physical collateral associated with the tent manufacturer.

In the example embodiment of FIG. 1, printers 130 are devices or entities able to generate large quantities of physical collateral based on received instructions from the collateral generation system 110. A printer 130 may be a device directly able to generate physical collateral, such as a large scale printer able to generate bulk qualities of unique physical collateral at high speeds. A printer 130 may also be an entity operating one or more such devices, for example a print shop controlling many large scale printers. For example, a printer 130 may receive a physical collateral plan describing a physical collateral item that may be generated based on the physical collateral plan. Printers 130 also may deliver physical collateral to an appropriate mail service 134 to be sent to its final destination. Each printer 130 can be associated with a different mail service 134. In some embodiments, printers 130 are integrated into the collateral generation system. In the embodiment of FIG. 1, two printers 130a and 130b are shown, but any number of printers may communicate with the collateral generation system 110. The printer interface 132 may be any suitable network or networks over which collateral generation system 110 may communicate with printers 130 such as over the Internet, direct Ethernet connection, or any other suitable network. For example, the printer interface 132 may be the same network as network 120. In some implementations, software features or modules allowing printers 130 to directly communicate with the collateral generation system 110 are integrated into the OEM software of a printer device.

In the embodiment of FIG. 1, a mail service 134 may be capable of delivering physical collateral 136 to a mailing address of a user. For example, the mail service 134 may be the United States Postal Service (USPS), UNITED PARCEL SERVICE (UPS), FEDERAL EXPRESS (FEDEX), or any other suitable mail (or courier) carrier. A mail service 134 can receive physical collateral for delivery from one or more printers 130. According to some example embodiments, mail carriers may offer a discount if mail is received pre-sorted, such as USPS carrier route or by geographical area. In some implementations, the mail service 134 provides tracking information to the collateral generation system 110. Tracking information can include an estimated date of arrival, delivery address, current location, and any other suitable information giving an indication of the status of the physical collateral or its progress to delivery.

### Collateral Generation System

FIG. 2 is a block diagram illustrating an example collateral generation system, according to one embodiment. In the embodiment of FIG. 2, the collateral generation system 110 may include a user information store 210, marketer rule store 212, and creative element store 214. In this embodiment, the collateral generation system 110 also includes an information processing module 220, verification module 222, marketer interface module 224, campaign management module 230, collateral creation module 240, printer interface module 250, direct analytics module 260, and publisher bidding module 270. In other embodiments, the collateral generation system 110 can include additional, fewer, or different modules or stores than the ones depicted in FIG. 2. For example, the functions of multiple modules may be combined into one module, or the functions of one module may be split across multiple modules.

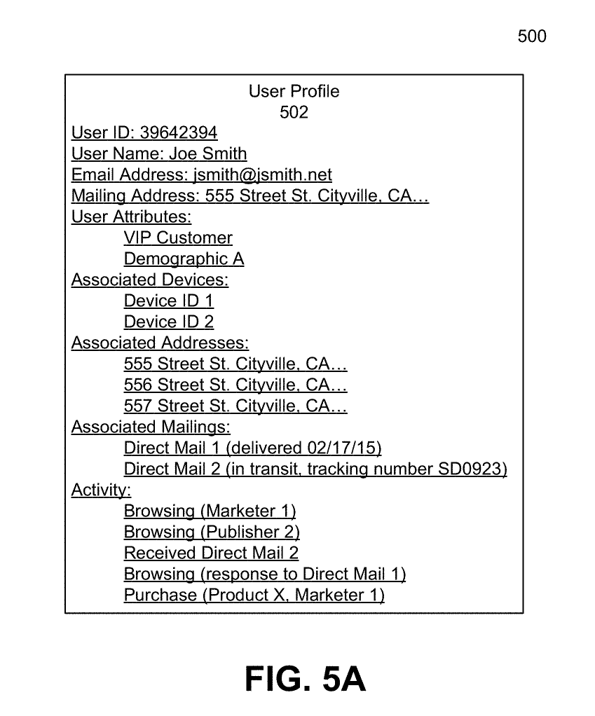

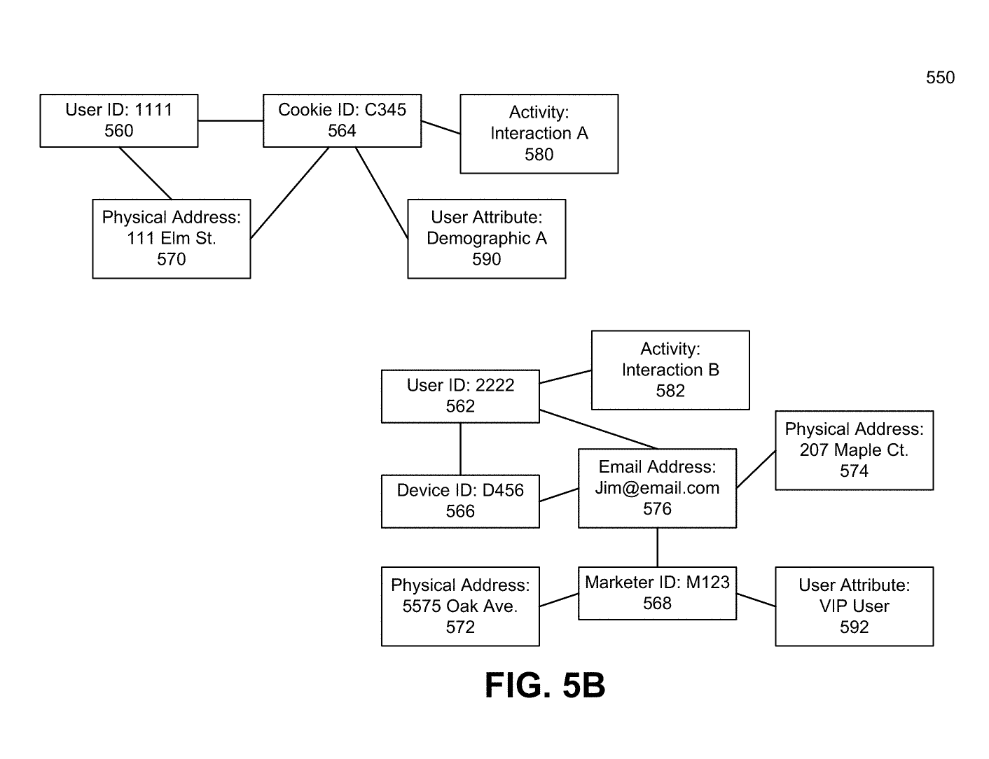

The user information store 210, in the example embodiment of FIG. 2, stores user information gathered about users 102, for example from marketers 122 or from user devices 104. User information may be stored in a database or any other suitable data storage system such as a system of user profiles or an address graph relating items of user information. The user information may be structured as a user profile. Reference will now be made to FIGS. 5A and 5B, which illustrate example methods of storing user information in the collateral generation system 110.

FIG. 5A illustrates an example user profile 502, according to one example implementation. In the example of FIG. 5A, the user profile 502 may have a user ID and user name identifying the user. A user ID may be a number or other identifier that identifying data associated with a specific user 102. For example, user activity data received from a marketer website or a cookie on a user device 104 may include the user ID of the associated user 102 and various user attributes of the user 102. A user attribute may be an item of user information identifying a specific characteristic of a user that may be used to target physical collateral mailings. In some embodiments, a user attribute may include demographic information about the user received from a marketer 122, third party, or any other suitable source. User attributes may also be marketer specific information, such as a “very important person” (VIP) status at a website associated with the marketer 122. The VIP status may, for example, correspond to memberships and/or loyalty programs. The user profile 502 also may contain contact information for the user, for example email addresses, phone numbers, or physical addresses for the user. Of the physical addresses a single mailing address for the user may be selected, indicating the most likely address to which physical collateral intended for the user can be delivered. For example, in the embodiment of FIG. 5A, the user profile contains three associated addresses and one mailing address.

The user profile 502 also may include information about interactions between the user and marketers 122, publishers 124, or the collateral generation system 110 (hereinafter “user activity data”). For example, in the embodiment of FIG. 5A, activities of the user such as browsing and purchasing are recorded. In some example implementations, items of user information are each associated with an individual marketer 122 or a publisher 124 in association with which that user information was received. For example, user activity information may be associated with specific marketers 122 and publishers 124 with which the user was interacting via an online website. Similarly, addresses, user attributes, and other user attributable information can be associated with one or more marketers 122 or publishers 124 associated with the user information. In some example implementations, marketers 122 may elect to collaborate or group with other marketers or publishers 124 within the collateral generation system 110. This collaboration may allow user information associated with one marketer 122 to be used in physical collateral generation for another collaborating marketer 122. For example, user address data can be shared between collaborating marketers. User profiles can contain records of actions related to a user 102 taken by the collateral generation system 110, such as the “associated mailings” section in the embodiment of FIG. 5A.

FIG. 5B illustrates an example address graph, according to one embodiment. In the embodiment of FIG. 5B, an address graph 550 contains graph nodes representing user IDs 560 and 562, cookie ID 564, device ID 566, marketer ID 568, physical addresses 570, 572, and 574, email address 576, user activity information 580 and 582, and user attributes 590 and 592. The address graph can be configured using rules programmed on a computer to achieve the desired behavior, such as the behavior described herein. In general, an address graph 550 may have nodes, each node representing a distinct item of user information, which are linked to related nodes based on the relationship between the user information of each node. Each node of the address graph may have user information, connections with related nodes, and other identifying information, such as an associated publisher or marketer. An address graph may be traversed to determine associations between various nodes of the address graph. For example, the address graph 550 may be traversed from the user ID 560 through the cookie ID 564 to the user activity information 580 to determine that the user ID 560 is associated with the user activity information 580. The address graph 550 may be stored within the collateral generation system 110 by any suitable by any suitable method, such as a database or table structure.

In some implementations, user information store 210 may contain information about groups of anonymous users, or groups user profiles without certain identifying information into an anonymous group. In some embodiments, the user profiles of anonymous users (anonymous user profiles) can contain a mailing address but are not associated with user activity information. In these embodiments, anonymous user profiles are associated with a larger group or pool of anonymous users and any user interaction collected for those users is associated with the anonymous pool rather than any individual user 102.

Returning to FIG. 2, the marketer rule store 212 may store information received from marketers 122 and publishers 124, according to the example embodiment of FIG. 2. The marketer rule store 212 can store collateral objectives and campaign goals associated with a marketer 122 as well as associations between a marketer 122 and publishers 124. In some embodiments, marketers 122 may store ranks or scores indicating the desirability of collateral objectives to the marketer. In some embodiments, the marketer rule store 212 may store associations between marketers, for example, collaboration instructions to share user information between associated marketers. For example, a marketer 122 may rank pages displaying products within a website to indicate which products to prioritize when sending physical collateral, for example, in a page hierarchy. For a certain marketer 122, a page hierarchy can be generated for that marketer's website, and for the websites of any associated publishers 124. Similarly, the marketer rule store 212 also may store incentives that can be offered though physical collateral, for example, a discount or promotional code and targeting information for selecting users to be mailed physical collateral. For example, targeting information may be based on demographics or user attributes, and comprise positive targeting information specifying desired qualities of users to be mailed to and negative qualities to avoid when mailing physical collateral. In some example implementations, information associated with publishers 124 also may be stored in marketer rule store 212, for example, a list of marketers 122 associated with the publisher 124, a ranking of pages within a publisher website, or any other suitable information.

The creative element store 214, in some example embodiments, may store creative elements used to generate physical collateral plans. Creative elements may include images, text, templates, and any other suitable information. For example, creative element store 214 may include a product photo, a product name, and a template describing a postcard. For example, a template can include physical characteristics of a physical collateral item, such as dimensions or a type of paper (e.g. cardstock) the physical collateral item will be printed on. In some implementations, a template may be a premade physical collateral plan defining a form factor, and including images, text, and wildcard fields indicating places where data is to be inserted. In other embodiments, a template may define a form factor only, and other content in the physical collateral plan is dynamically assembled using other creative elements.

The information processing module 220 may receive information from user devices 104, marketers 122, publishers 124, and other appropriate sources, according some embodiments. In some implementations, received information can be associated with users 102, user devices 104, marketers 122, publishers 124, or any combination of the above. For example, information processing module 220 can receive user activity or purchase information from a marketer 122 associated with a user 102, for example through a user ID, and the marketer 122. Users 102 also may be recognized based on a device ID of an associated device, through analysis of the data itself, or through any other suitable method. Similarly, the information processing module 220 may receive user activity information from user devices 104. Information received from a user device 104 can also be associated with a device ID indicating which device the information was received from. In some example implementations, received information may be stored in an address graph in nodes connected to each other and preexisting nodes based on the relationships between the received information and existing information in the address graph. For example, in the embodiment of FIG. 5B, additional information is received that Jeff@email.com (an email address) may be associated with the user ID 1111. First the address graph is searched for this information. The user ID 1111 may be represented by the node 560, but a new node may be created for the email address. Based on the connections between the Jeff@email.com email address and the user ID 1111, the newly created node may be generated with a connection to the user ID node 560.

In some cases, the information processing module 220 may receive and may process information on anonymous users. Anonymous users may be users without an associated user ID and, in some embodiments, anonymous users also are not identified by any marketers 122. In some embodiments, the information processing module 220 groups anonymous users into one or more anonymous user pools. For example, an anonymous user pool may be a group of anonymous users sharing similar characteristics. Information received associated with an anonymous user (e.g. from a user device 104 associated with that user) of an anonymous user pool may be associated with the anonymous user pool rather than the anonymous user. After reaching a threshold size, members of the anonymous user pool may be mailed collectively based on aggregated information characteristic to the anonymous user pool or individually based on their association with the anonymous user pool.

In one embodiment, the verification module 222 checks and stores received information. For example, received user information may be verified by cross checking with other received user information by the same user, for example from a different marketer, or across multiple other users. Users 102 may be associated with multiple user devices 104, for example, a user 102 associated with both a phone and a laptop. In these situations, the verification module 222 may associate the user 102 with both user devices 104. In some implementations, user devices 104 of a user 102 devices are not linked in the collateral generation system, for example, when a user begins using a new or different user device 104. In the case where a user 102 begins using a new user device 104 the verification module 222 may, for example, compare new information associated with the newer device with information obtained from a previous device associated with the user 102 and determine that the newer device should also be associated with the user 102. In some implementations, the verification module 222 optimizes an address graph, for example by pruning nodes and connections unlikely to be significant. For example, nodes can be eliminated based on number of connections or with connections that are accumulated at greater than a threshold rate. For example, public computers, such as a library computer, are likely to accumulate a large number of connections in a short amount of time, and are therefore unlikely to offer useful information about any single user and can be eliminated from the address graph.

The verification module 222 also may select a likely mailing address for a user. In some embodiments, the verification module 222 takes last date of use, frequency of use, and address type into account when selecting a mailing address, for example, the verification module 222 may select the most commonly used residential shipping address associated with the user as the mailing address for that user. In other embodiments, an address graph may be traversed to determine an address associated with a user based on given information about the user. For example, in the embodiment of FIG. 5B, if the collateral generation system 110 determines an address associated with the device ID “D456” to send associated physical direct mail, the address graph may be traversed to determine a likely physical mailing address. In this example, the address graph is traversed starting at the device ID node 566 corresponding to the device ID “D456.” In some implementations, after the traversal the nearest (in terms of graph distance or number of intermediate nodes) physical address node is the physical address node 574 corresponding to the physical address, e.g., 207 Maple Ct. address. If, for some reason, the 207 Maple Ct. address is not suitable for mailing (such as a non-existent address), the next-nearest address is determined, e.g., in this example the 5575 Oak Ave. address. Alternatively, a physical address for mailing can be selected out of multiple options (for example, determined by traversing the address graph) based on direct connections or other attributes of the address. For example, a physical address can be selected based on the direct connections of the address such that an address directly connected to a marketer ID can be selected over other addresses not directly connected to a marketer ID. Additionally, any suitable attributes of an address or a physical address node can be used to select a physical address for mailing.

Mailing addresses also may be verified against appropriate databases, for example, if a mailing address is a business address it can be checked with a business registry or other data source to verify the correctness of the address. Past user activity data can also be used to select a mailing address, for example, patterns of responses of a user can detect seasonality in addresses. In some example implementations, user addresses may be verified with a mail service to ensure that physical collateral sent to that address will be deliverable, for example mailing addresses can be verified using USPS verification data.

In the example embodiment of FIG. 2, the marketer interface module 224 allows marketers 122 to manage campaigns, set collateral objectives and campaign goals, and receive analysis results. Similarly, the marketer interface module 220 also may interface with publishers 124. For example, a marketer 122 may associate certain pages of a marketer website with specific collateral objectives or define campaign goals for a campaign using physical collateral.

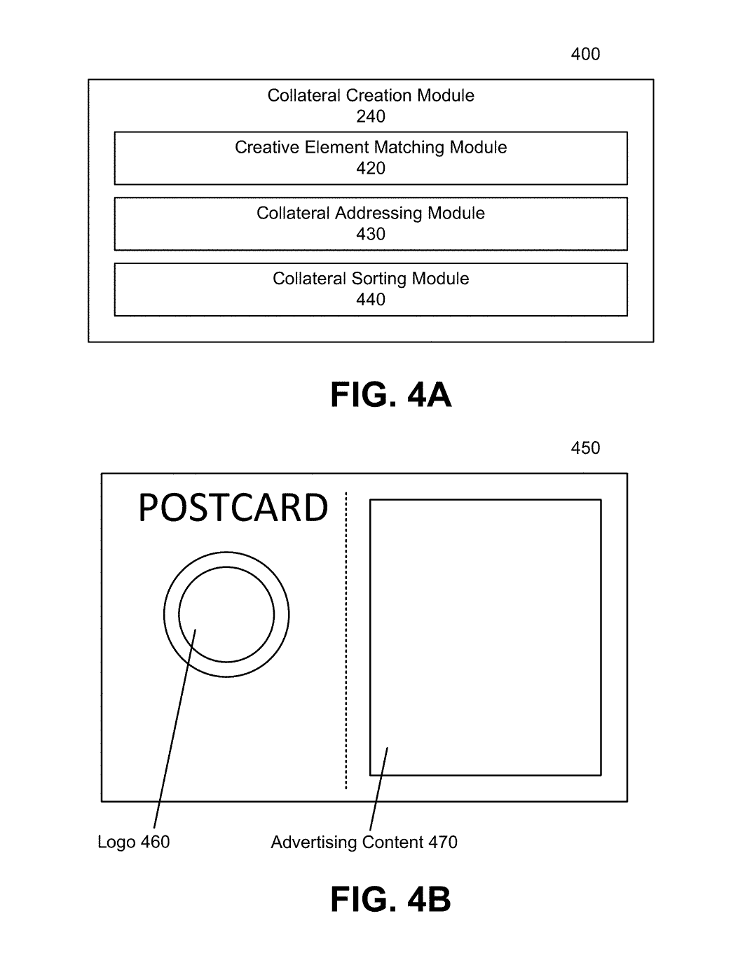

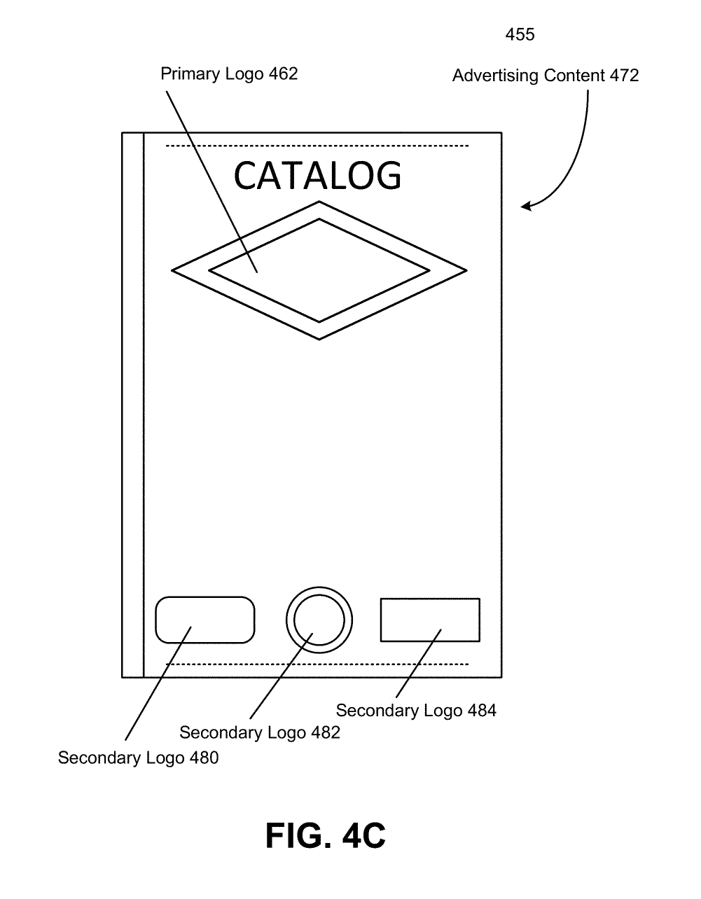

The campaign management module 230 may select users, collateral objectives, and incentives for which physical collateral will be generated, according to the embodiment of FIG. 2. Users 102 may be selected based on user demographics, user attributes, and/or associations with a campaign objective, for example, membership in a relevant demographic group, possession of a relevant user attribute, or online activity relevant to a campaign objective. For example, a user 102 can be selected based on user activity data showing that the user has recently viewed a product on a website associated with a campaign objective and that the user is a VIP member with the associated marketer. A campaign objective and incentive may then be selected for the user. The campaign management module 230 is discussed in further detail in reference to FIG. 4A-4C.

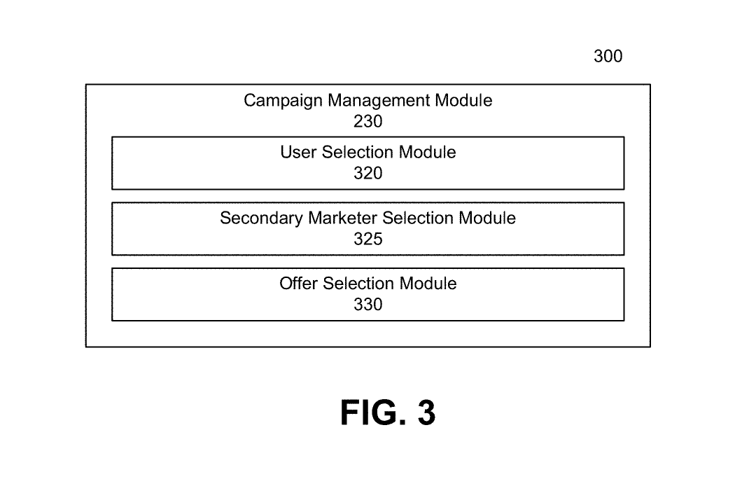

The collateral creation module, in the embodiment of FIG. 2, assembles physical collateral plans based on a selected user and incentive. In some embodiments, the collateral creation module may assemble creative elements from the creative element store 214 and relevant user information, such as an address or name, to form a physical collateral plan. The collateral creation module 240 is discussed in further detail in reference to FIG. 3.

In the embodiment of FIG. 2, the printer interface module 250 communicates with printers 130 over the printer interface 132. The printer interface module 250 may provide physical collateral plans to printers 130. Printers 130 can require specific formats and, in some embodiments, the printer interface module 250 can convert the format of a physical collateral plan based on which printer 130 the plan will be sent to. The printer interface module 250 may send physical collateral plans to printers 130 by any suitable method required by the printer 130, such as email or over a file transfer protocol (FTP).

The direct analytics module 260 may analyze received user activity data and physical collateral tracking information to determine statistics or analysis about a specific physical collateral item, a collateral objective, or a campaign goal. To determine if a user has responded to the physical collateral mailing the direct analytics module 260 may analyze user activity associated with a user and tracking information associated with a specific physical collateral item mailed to the user. In some implementations, a user is considered to have responded to a physical collateral mailing if they return to the marketer 122's website or store within a threshold amount of time from receiving the mailing. Similarly, a user 102 may be considered a “conversion” each time they interact with the marketer 122 within a threshold amount of time from receiving the mailing. In some cases, conversions may be based on user purchases from an online store of a marketer 122. User purchases can be determined based on information received from the marketer 122 or user 124, for example, linked to a marketer ID, device ID, or other user ID. In some embodiments, information in an address graph is used to determine conversions based on user activity information added to the address graph. For example, the address graph can be traversed starting from user activity information representing a conversion to find user IDs, marketer IDs, or device IDs associated with a previous mailing.

The direct analytics module 260 also may generate overall statistics about a collateral objective or campaign goal across a wide range of users 102. User response or conversion data can be compiled by the direct analytics module 260 to generate response and conversion statistics. For example, user response data may be compared to the total number of users mailed physical collateral to determine a response percentage. The direct analytics module 260 also may utilize other user, marketer, or publisher information to generate more detailed statistics, for example, the direct analytics module 260 can use geographic data (for example the mailing address of a user) to generate localized response and conversion statistics. Response and conversion statistics may be organized by state, by county, by date, or by any other suitable method and can represent overall response and conversion rates for a publisher, response and conversion rates for a specific collateral objective or incentive, or by any other suitable method. In some implementations, these statistics may be displayed using a map, such as a heatmap with high conversion or response rates in one color, and low conversion or response rates in a different or contrasting color.

In the embodiment of FIG. 2, the publisher bidding module 270 may determine a marketer 122 associated with a publisher 124 to send physical collateral in response to user activity associated with the publisher 124. Publishers 124 may have multiple associated marketers 122 for which physical collateral can be sent based on data received from the publisher 124. In some implementations, a user 102 will not receive multiple physical collateral mailings based on the same user activity data. Therefore, in some embodiments, the publisher bidding module determines which marketer's 122 physical collateral a given user action will be associated with. In one implementation, this may be determined based on an auction system, where marketers 124 are able to enter bids and the highest bidding marketer 124 is selected to send physical collateral based on the user activity data. Alternatively, a set of marketers for a physical collateral item may be selected to send physical collateral based on the auction system. In other implementations, publishers 124 can select a marketer 122 to send physical collateral based on a given user action by any suitable method or business rules, for example by publisher hierarchy. In some implementations, physical collateral items sent based publisher provided user data are associated with the publisher in some way, for example by a logo of the publisher.

Similarly, publishers 124 may be viewed as primary marketers for physical collateral items generated based on that publisher or using user activity data provided by the publisher. In these embodiments, other marketers associated with the physical collateral item can be viewed as secondary marketers for the physical collateral item. For example, the highest bidding marketer 122 selected by the publisher bidding module 270 can be selected as a secondary marketer based on having the highest bid in the auction.

### Campaign Management

FIG. 3 is a block diagram illustrating an example campaign management module, according to one example embodiment. In the embodiment of FIG. 3, the campaign management module 230 may include a user selection module 320, a secondary marketer selection module 325, and an offer selection module 330. In other embodiments, the campaign management module can include additional, fewer, or different modules. The campaign management module 230 may select users to receive physical collateral and determine which collateral objectives and incentives that mailing will follow. The selection of users 102 may be based on the associated marketer's campaign goals and collateral objectives as well as collected user data, for example user activity data suggesting an association with a campaign objective. The selection of collateral objectives may be based on user association, campaign goals, and marketer ranking of the collateral objectives.

In some embodiments, a primary marketer for the physical collateral item may be selected first, for example, based on user interaction with the primary marketer and secondary marketers may later be chosen based on user association, campaign goals, and/or secondary marketer ranking of collateral objectives. According to some example implementations, user activity information or other user information used by the collateral generation system 110 to select the primary and secondary marketers, for example, user browsing data received from an electronic cookie on the user device, is not exposed to the secondary marketers.

The user selection module 320, according to the example embodiment of FIG. 3, selects users 102 to receive physical direct mail based on the campaign goals of one or more marketers 122, for example, the primary marketer, and information stored within the user profile store 212 and marketer rule store 214. Users 102 may be selected based on demographic information, user attributes, or association with one or more collateral objectives. In some embodiments, positive or negative targeting criteria may be used to select users for physical collateral mailings. For example, the user profile 502 for a user may contain user activity data that the user has viewed but not purchased a product. In some implementations, the campaign management module determines which users 102 will receive direct mail by assigning scores to each user 102 based on a weighting function and selecting users ranked above a threshold number. Alternatively, all users 102 with a score above a threshold number may be selected. User selection also may be made based on the campaign goals of a marketer 122. For example, if a marketer-set target for mailings about a specific promotion or collateral objective is met, the user selection module 320 can stop selecting users associated with that incentive or collateral objective. In some embodiments, the user selection module 320 also may select an anonymous pool of users to receive physical collateral. In some implementations, only anonymous pools with greater then a threshold number of users are selected to be mailed.

According to some embodiments, the secondary marketer selection module 325 selects secondary marketers for a physical collateral mailing based on the primary marketer, user activity data of the associated user, campaign goals of the primary or secondary marketers, or for any other suitable reason. A physical collateral item incorporating both a primary marketer and a secondary marketer can be, for example a catalog incorporating ad content, offers, or products for both the primary marketer and the secondary marketer(s). In some embodiments, secondary marketers may be selected based on a previous association, rule, or partnership stored within the collateral generation system. For example, an online retailer may partner with a manufacturer so physical collateral sent by the manufacturer also can direct customers to the retailer to purchase the manufacturer's product. Similarly, secondary marketers may be dynamically selected based on the results of an auction, such as the auction system employed by the publisher bidding module 270, or based on user interest in products.

The offer selection module 330 selects collateral objectives and incentives for users selected by the user selection module 320, according to the example embodiment of FIG. 3. In some implementations, each physical collateral item is associated with multiple collateral objectives. In situations where a selected user 102 is associated with multiple collateral objectives, for example multiple products sold by a marketer 122, the offer selection module 330 may select which collateral objectives to associate with the physical collateral mail. Selection of collateral objectives can be based on marketer campaign goals, for example, a marketer-provided ranking of collateral objectives. In the example of a marketer-provided ranking of collateral objectives, collateral objectives can be selected both by ranking and user association with the collateral objective. For example, a low ranked objective may be selected over a higher ranked one is the user is more strongly associated with the lower ranked objective. Collateral objective and incentive selection can also be based on user actions, demographics, and user attributes. For example, users' past actions and previous responses to physical collateral with incentives may be taken into account in determining incentives to offer. For example, if a user 102 has received both physical collateral offering a free shipping incentive and physical collateral offering a 10% discount incentive but has only responded to the free shipping incentive, the offer selection module 330 may select to offer the free shipping incentive based on this information.

Similarly, collateral objectives can be associated with specific products or services. In some embodiments, the selection of collateral objectives is based on the stock level of products associated with each collateral objective. For example, collateral objectives can be chosen based on the associated product being in stock or on clearance. This information can be received from marketers 122. Similarly, collateral objectives can be chosen based on the price or profit margin of the associated products. In embodiments where a single physical collateral item is associated with multiple marketers, collateral objectives can be selected based on marketer association.

### Collateral Creation

FIG. 4A is a block diagram illustrating an example collateral creation module, according to one example embodiment. In the embodiment of FIG. 4A, the collateral creation module 240 includes a creative element matching module 420, a collateral addressing module 430, and a collateral sorting module 440. In other embodiments, the campaign management module can include additional, fewer, or different modules. The collateral creation module 240 can receive a selection of a user 102, collateral objective, and an incentive and generate an appropriate physical collateral plan to be transmitted to a printer.

The creative element matching module 420 selects and assembles creative elements and user data to form a physical collateral plan, according to the example embodiment of FIG. 4A. For example, after receiving a selection of a user, collateral objective, associated marketer, and incentive if applicable the creative element matching module may select a template and other creative elements based on the received information. For example, a collateral objective may be associated with a specific form factor, for example a postcard, and marketer, for example a hiking equipment manufacturer, and the creative element matching module 420 may select a template based on this restriction. In some implementations, templates require all wildcards to be filled out to appear as intended, in these cases the absence of a field may leave an unintended space in text or render the physical collateral plan nonsensical. Alternatively, a template can dynamically adapt to available information, such as by adjusting content based on missing information for a wildcard field. For example, a dynamic template featuring a product photo may rearrange, change, or enlarge surrounding text if a suitable product photo is not available. In some implementations, templates have no wildcard fields and define only a form factor of the physical collateral item. In these implementations, the physical collateral plan can be assembled out of non-template creative elements based on user information, collateral objective, incentive, and associated campaign goals.

FIG. 4B illustrates an example physical collateral item associated with an example marketer, according to one embodiment. The physical collateral item 450 of FIG. 4B may include an optional logo 460 and advertising content 470. The logo 460 may represent the logo of the marketer associated with the physical collateral item 450. In this example, the advertising content 480 can represent advertising content associated with the marketer. In the embodiment of FIG. 4B, the physical collateral item 450 may be a postcard associated with a single marketer, though a physical collateral item associated with a single marketer can also be a catalog, letter, or other physical collateral item. In other embodiments, a physical collateral item may be associated with multiple marketers.

FIG. 4C illustrates an example physical collateral item associated with multiple marketers, according to one embodiment. The physical collateral item 455 of FIG. 4C may include a primary logo 462, secondary logos 480, 482, and 484, and advertising content 472. The primary logo 462 can represent the logo of a primary marketer associated with the physical collateral item 455. Similarly, the secondary logos 480-484 may represent secondary marketers also associated with the physical collateral item. In this example, the advertising content 472 may represent advertising content associated with both primary and secondary marketers. For example, the physical collateral item 455 may be a catalog containing multiple products.

Returning to FIG. 4A, in an embodiment, the collateral addressing module 430 inserts or verifies mailing addresses, tracking barcodes, and return addresses into physical collateral plans. In some implementations, mailing addresses may be verified by the collateral addressing module before being inserted into the physical collateral plan. For example a mailing address may be verified against a database such as the National Change Of Address database (NCOA), and the address format may be checked and corrected, for instance by a CASS (Coding Accuracy Support System) certified matching process. The collateral addressing module 430 may insert an appropriate tracking barcode, QR code, or other tracker or identifier based on the mail service 134 to be used. A return address may be dynamically selected for each physical collateral item based on the marketer 122 or marketer rules provided by the marketer, the mailing address of the user, or for any other suitable reason. In some implementations, an address associated with the collateral generation system is an option for the return address.

The collateral sorting module 440 may associate physical collateral plans with printers 130 and determine a correct order or sorting of the physical collateral plans, according to the example embodiment of FIG. 4A. As discussed above, a collateral generation system 110 may be connected to multiple printers 130. These printers may differ in geographic location and generating a physical collateral item closer to its final destination may result in more efficient delivery, both in cost to deliver and time to delivery. Consequently, in some implementations the collateral sorting module 440 may assign physical collateral plans to different printers based on geographic location, estimated time to delivery, estimated cost of delivery, or other suitable factors. Physical collateral plans received by the collateral generation system may be split between any number of associated printers 130. As physical collateral plans may fully describe the physical collateral item, for example including a verified address of the recipient, in some embodiments, printers 130 have only to print the file as given and deliver it to the appropriate mail service 134. Similarly, as discussed above, a mail service 134 may allow pre-sorting of mail to further increase efficiency. In some implementations, the collateral sorting module can also pre-sort the physical collateral plans so printed physical collateral will be in sorted order. For example, a mail service 134, such as the USPS, may allow mail to be pre-sorted by carrier route. In some embodiments, the functions of the collateral sorting module 440 may be separated across two modules, a printer routing module and a route sorting module. In these embodiments, the printer routing module may direct pieces of physical collateral to different printers 130 based on location, cost, or other factors, and the route sorting module can pre-sort physical collateral plans for mail services 134.

### Collateral Generation User Interface Examples

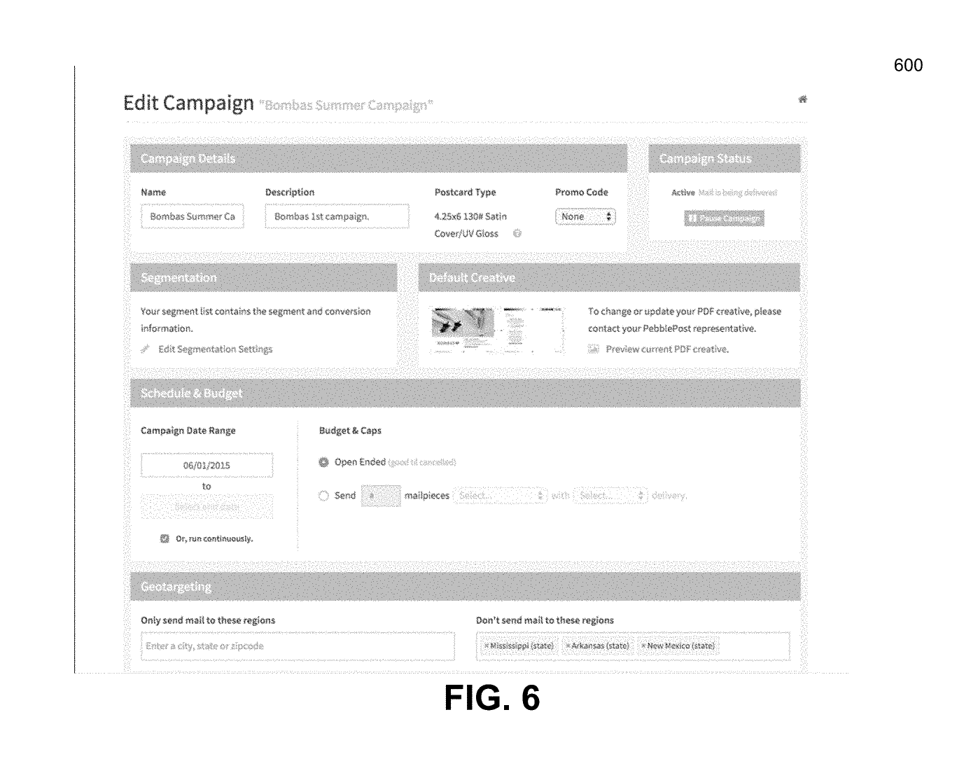

FIG. 6 illustrates an example user interface for defining a campaign, according to one implementation. The user interface 600 provides the ability for marketers 122 to define campaign goals and incentives within collateral generation system 110, according to the embodiment of FIG. 6. For example, the user interface 600 provides a “schedule & budget” and “geotargeting” sections allowing a marketer 122 to define campaign goals. Similarly, the user interface 600 can allow a marketer 122 to associate an incentive or incentives with the campaign, such as the “promo code” dropdown box.

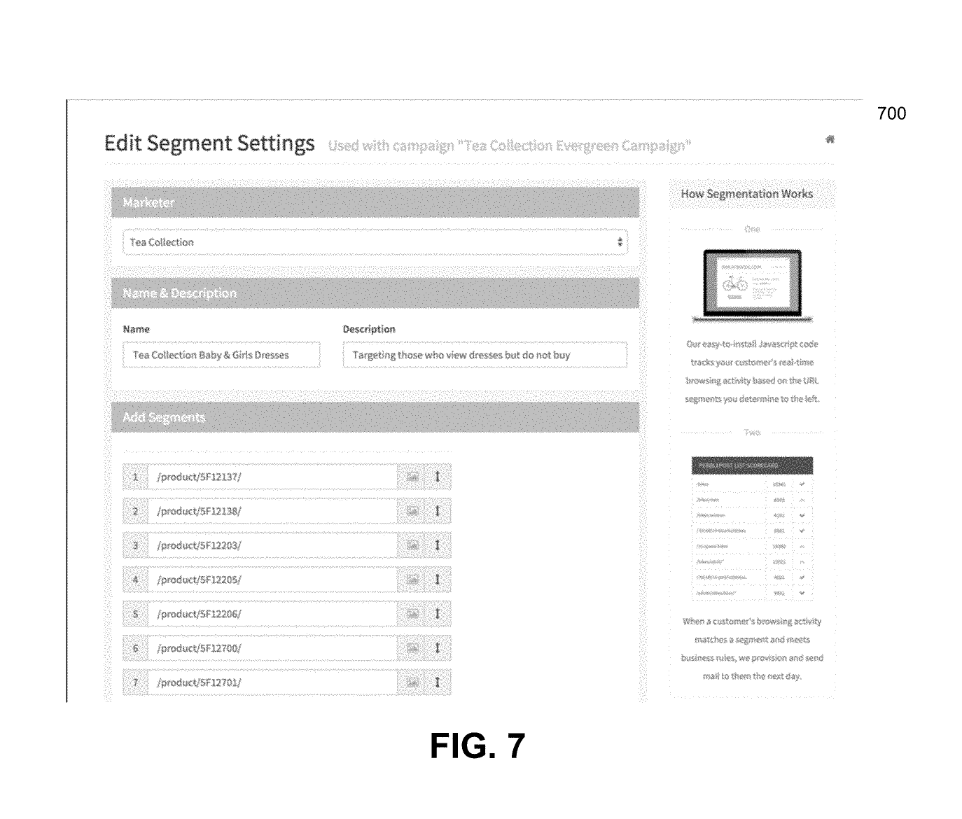

FIG. 7 illustrates an example user interface for defining collateral objectives, according to one implementation. The user interface 700 allows a marketer 122 to define collateral objectives associated with a campaign. For example, the user interface 700 provides a listing of “segments” representing collateral objectives, in this case products.

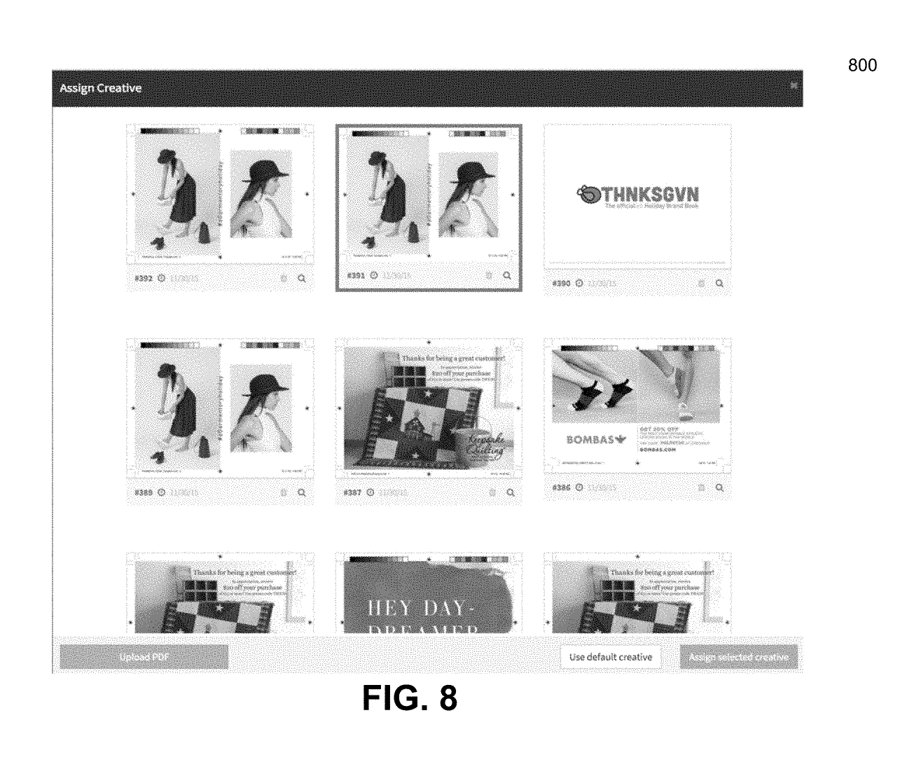

FIG. 8 illustrates an example user interface for associating creative elements with a collateral objective, according to one implementation. In this example, the user interface 800 shows a list of various creative elements which may be assigned to a collateral objective.

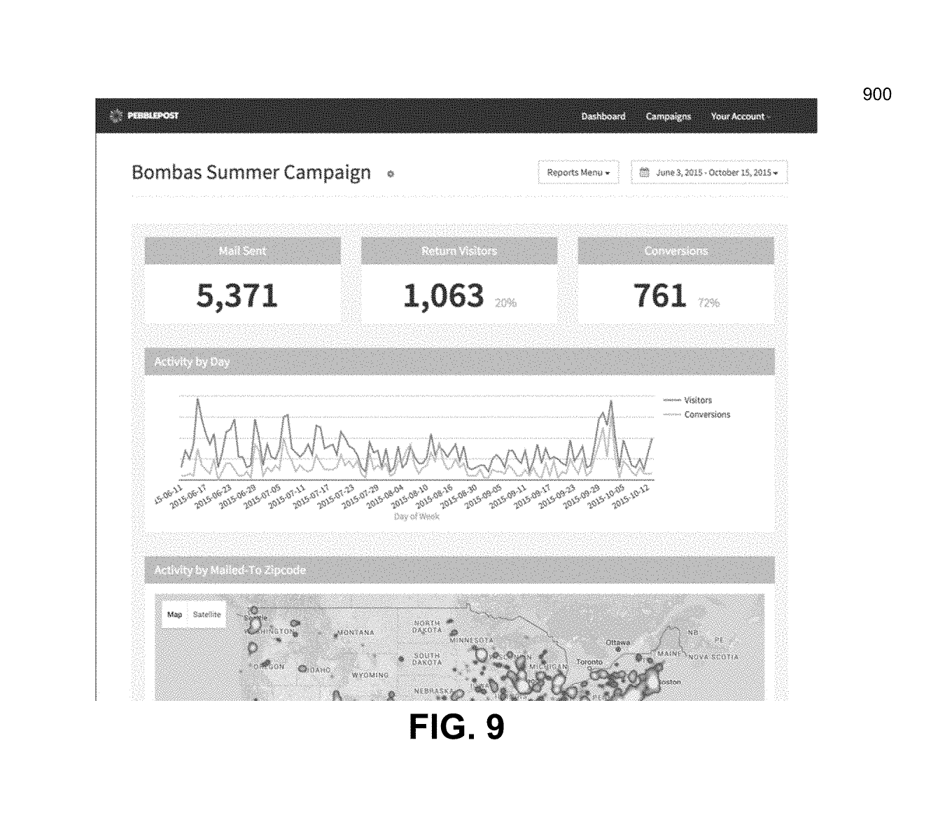

FIG. 9 illustrates an example user interface displaying analysis results of a marketing campaign. The user interface 900 may display analysis results to a marketer 122. For example, the user interface 900 displays a conversion rate, activity by day chart, and activity heatmap.

### Example Process for Sending Physical Collateral

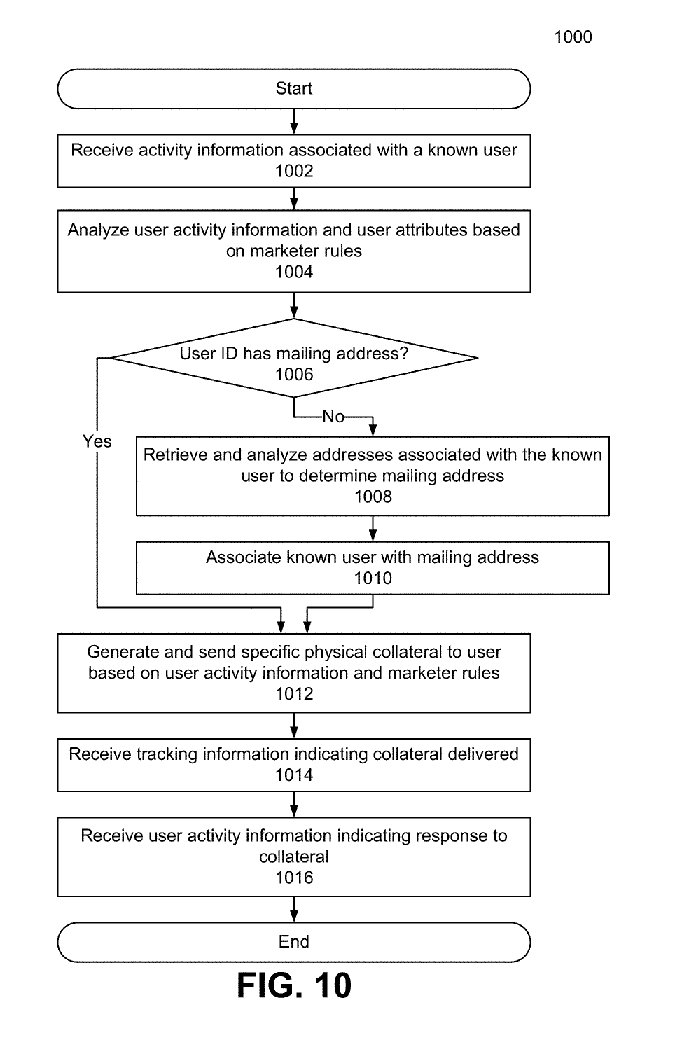

FIG. 10 illustrates an example process for generating and mailing specific physical collateral, according to one example embodiment. Process 1000 begins with the collateral generation system 110 operational to receive 1002 activity information associated with a known user. The collateral generation system 110 analyzes 1004 user activity information and user attributes based on marketer rules to determine if the user is to be mailed physical collateral. The collateral generation system determines 1006 if the user ID is associated with a mailing address. If no mailing address is associated, a addresses associated with the known user are retrieved 1008 and analyzed to determine a likely mailing address, and the user is associated 1010 with that mailing address. For example, user profile or address graph information can be analyzed to determine a mailing address. In either case, the collateral generation system 110 can generate and send 1012 physical collateral to the known user. Once the physical collateral is sent, tracking information indicating the delivery of the physical collateral may be received 1014. This tracking information may be analyzed along with received 1016 user activity information to determine that the user responded to the physical collateral mailing.

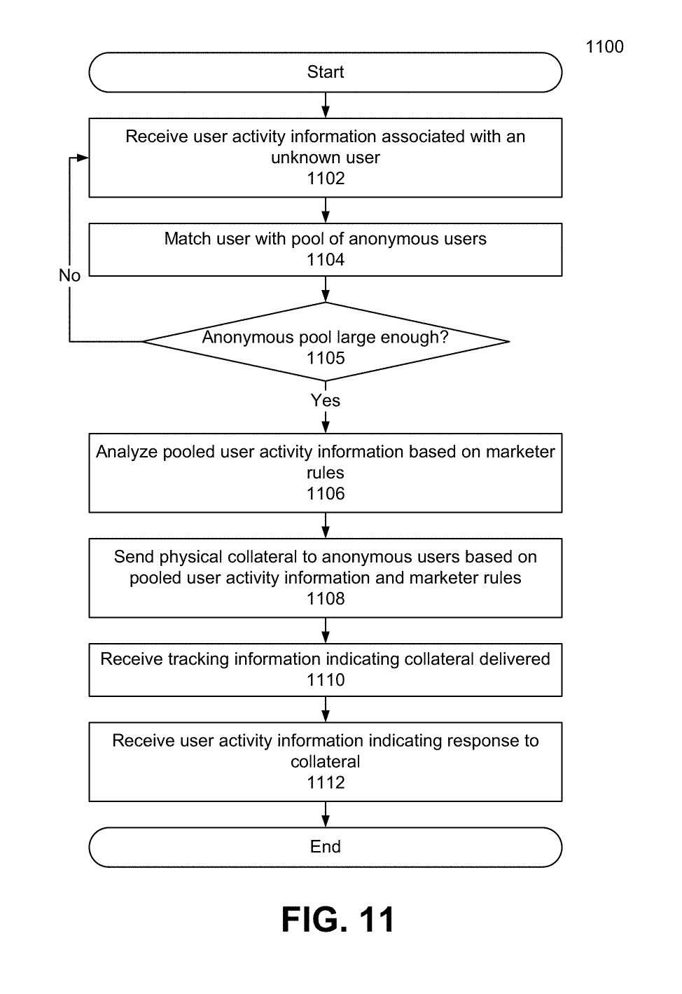

FIG. 11 illustrates a second example process for generating and mailing specific physical collateral, according to one embodiment. Process 1100 begins with the collateral generation system 110 operational to receive 1102 user activity information associated with an unknown user. Based on this the unknown user may be matched 1104 with a pool of anonymous users. When the pool reaches a threshold amount of users 1105, the pooled user activity information may be analyzed 1106 based on marketer rules. Based on this analysis, the collateral generation system 110 may generate and send 1108 physical collateral to members of the anonymous pool. Similar to the previous example, after the physical collateral is sent, tracking information indicating the delivery of the physical collateral can be received 1110. This tracking information can then be analyzed along with received 1112 user activity information to determine that the user responded to the physical collateral mailing.

### Example Process for Generating and Tracking Physical Collateral

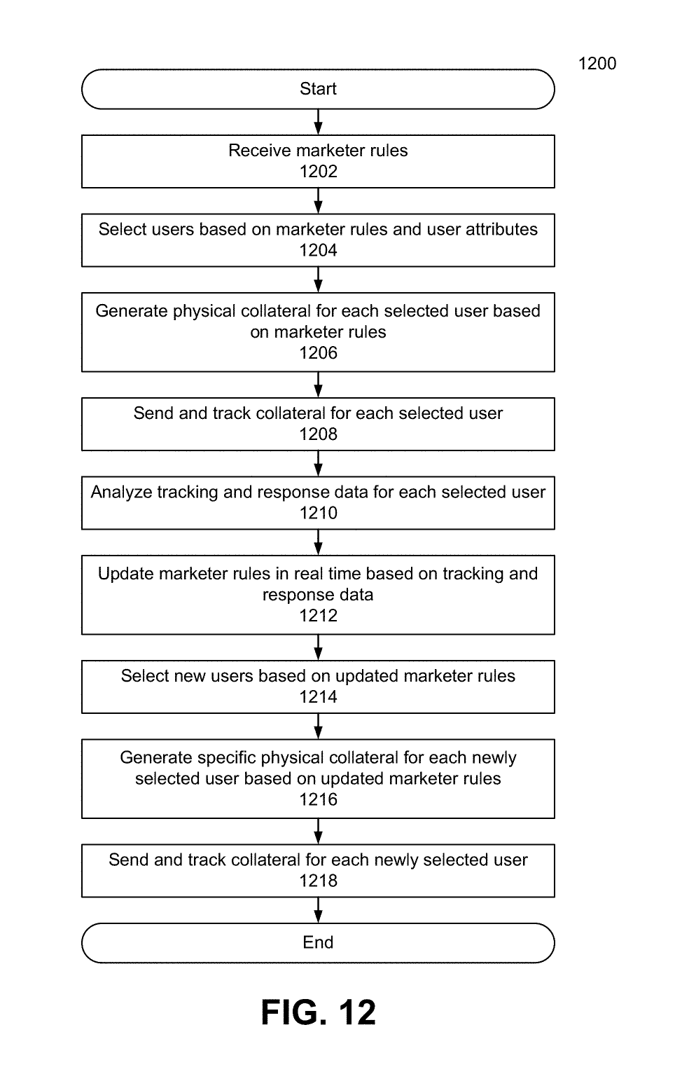

FIG. 12 illustrates an example process for generating and tracking physical collateral, according to one example embodiment. In the embodiment of FIG. 12, process 1200 starts as the collateral generation system 110 receives marketer rules from a marketer 122. Based on the marketer rules and user information and attributes, users may be selected 1204 to receive physical collateral associated with that marketer 122. Physical collateral for each selected users may be generated 1206 based on the marketer rules. After the physical collateral is sent, it may be tracked 1208 individually for each selected user. The tracking data and user activity data indicating responses or conversions to the physical collateral may be analyzed 1210 to update the marketer rules 1212. A new set of users may be selected based on the updated marketer rules 1214, and physical collateral may be generated 1216, sent and tracked to each newly selected user 1218.

### Example Process of a Physical Collateral Marketplace

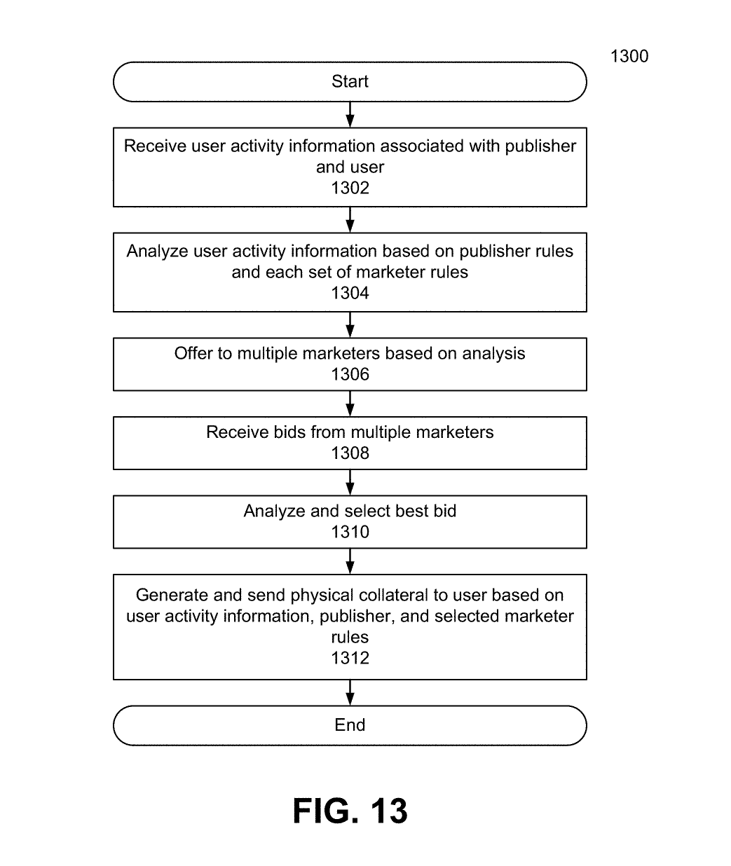

FIG. 13 illustrates an example process of a physical collateral marketplace, according to one embodiment. Process 1300 begins with the collateral generation system 110 operational to receive 1302 user activity information associated with a publisher 124 and a user. The user activity information may be analyzed 1304 based on publisher rules and associated marketer rules to determine marketers to offer 1306 the opportunity to send physical collateral to. Bids from marketers can then be received 1308, and the best bid may be selected 1310. Physical collateral may be generated and sent 1312 based on the user activity information received from the publisher.

### Example Process of Multiple Marketer Physical Collateral Generation

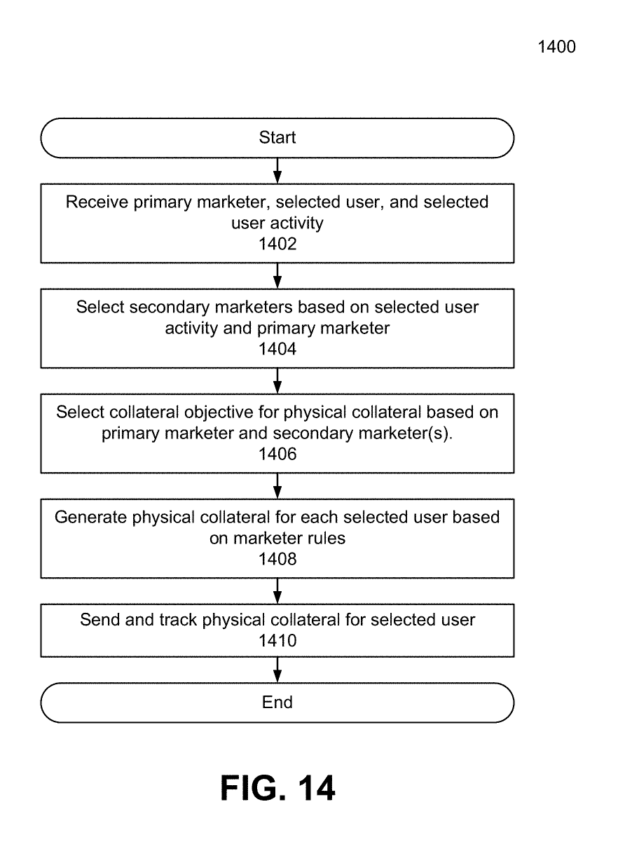

FIG. 14 illustrates an example process for generating a physical collateral item associated with multiple marketers, according to one embodiment. Process 1400 begins with the collateral generation system 110 operational to receive 1402 information about a selected primary marketer, user, and user activity for a physical collateral mailing to be associated with multiple marketers. The collateral generation system 110 may select 1404 additional secondary marketers based on the received information. The collateral objectives for the physical collateral mailing can be selected 1406 based on the primary and secondary marketers and the physical collateral may generated 1408. Finally, the physical collateral may be sent 1410 to the selected user.

### Additional Considerations

A collateral generation system 110 can provide many advantages to users 102 and marketers 122. In some implementations, a collateral generation system can generate and send physical collateral based on user actions or other data received that day or the day before. Similarly, collateral generation system 110 can personalize physical collateral items for a user 102 based on actions of that user 102. In this way, a user 102 can receive a physical collateral item 136 relevant to their current situation both in content and in timing. Additionally, tracking and analytics information provided to marketers 122 from the collateral generation system 110 can allow marketers 122 to better manage any marketing campaigns or promotions involving physical collateral. For example, the results, measured in response or conversion rate, of physical collateral created using a collateral generation system 110 can be improved (for example, a higher response or conversion rate) when compared to a generic, non-personalized direct mail system.

Additionally, the collateral generation system 110 can efficiently distribute physical collateral to printers 130. Because physical collateral plans contain all information on associated physical collateral items, physical collateral associated with multiple marketers 122 and publishers 124 can be split among many printers 130 and mail services 134 for generation and delivery. In some embodiments, this allows printers to be selected based on cost, location, printing capability (for example, for unusual materials or form factors), or for any other suitable reason.

The disclosed configuration enables using periodically collected (e.g., daily) information for the purpose of generation of customized physical collateral on a large scale. Physical collateral can be generated based not only on personalization for the recipient, but also based on marketer rules, and other relevant user activity data, for example response or conversion data recently received from the intended recipient of the physical collateral, or from other recipients of similar physical collateral.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms, for example, as illustrated and described through the FIGS. herein. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors, e.g., processor, that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for collateral generation system for direct mail through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for generating and sending specific direct mail, the method comprising:
receiving, from a collateral provider, online user activity information associated with identifying user information stored within a collateral generation system, the identifying user information associated with a user of the collateral provider;
determining, based on the user activity information based and a set of rules associated with the collateral provider that the user should be sent physical collateral;
identifying one or more addresses stored in the collateral generation system, each address of the set of addresses associated with the identifying user information;
selecting a physical mailing address for the physical collateral from the identified one or more addresses; generating a file for specific physical collateral based on the user activity information and the rules associated with the collateral provider; and
transmitting the file for the specific physical collateral to a production device for generation of the specific physical collateral to provide for delivery to the physical mailing address.

2. The method of claim 1, wherein receiving online user activity information associated with identifying user information comprises:
generating a first node representing the online user activity information within an address graph of the collateral generation system, the address graph comprising a plurality of nodes linked with edges; and
associating the first node with a second node of the address graph, the second node representing the identifying user information.

3. The method of claim 2, wherein identifying one or more addresses stored in the collateral generation system comprises:
traversing the address graph from the second node representing the received user identifying information to one or more nodes representing received addresses; and
identifying the set of addresses associated with the one or more nodes and the graph distance between the second node representing the received user identifying information and each node representing a physical address of the set of physical addresses.

4. The method of claim 3, wherein selecting a physical mailing address for the physical collateral from the identified one or more addresses comprises:
determining the graph distance between each node representing a physical address of the set of physical addresses and the second node representing the received user identifying information; and
selecting the address associated with the shortest graph distance as the physical mailing address.

5. The method of claim 1, wherein identifying one or more addresses stored in the collateral generation system comprises:
accessing a user profile associated with the identifying user information within the collateral generation system; and
retrieving one or more addresses stored in the user profile.

6. The method of claim 1, wherein determining that the user should be sent physical collateral comprises selecting to be sent physical collateral based on targeting criteria associated with the collateral provider.

7. The method of claim 1, wherein generating a file for specific physical collateral based on the user activity information and the rules associated with the collateral provider comprises assembling a creative template, creative elements, and the online user activity information associated with the identifying user information.

8. The method of claim 1, wherein generating a file for specific physical collateral based on the user activity information and the rules associated with the collateral provider comprises verifying the mailing address against the NCOA (National Change Of Address) database.

9. The method of claim 1, further comprising:
receiving, from a physical delivery carrier, tracking information on the delivery of the specific physical collateral; and
associating the tracking information with the identifying user information within the collateral generation system.

10. A non-transitory computer readable storage medium comprising instructions that when executed by at least one processor causes the processor to:
receive, from a collateral provider, online user activity information associated with identifying user information stored within a collateral generation system, the identifying user information associated with a user of the collateral provider;
determine, based on the user activity information based and a set of rules associated with the collateral provider that the user should be sent physical collateral;
identify one or more addresses stored in the collateral generation system, each address of the set of addresses associated with the identifying user information;
select a physical mailing address for the physical collateral from the identified one or more addresses;
generate a file for specific physical collateral based on the user activity information and the rules associated with the collateral provider; and
transmit the file for the specific physical collateral to a production device for generation of the specific physical collateral to provide for delivery to the physical mailing address.

11. The non-transitory computer readable storage medium of claim 10, wherein the instructions to receive online user activity information associated with identifying user information further comprises instructions that when executed by the processor causes the processor to:
generate a first node representing the online user activity information within an address graph of the collateral generation system, the address graph comprising a plurality of nodes linked with edges; and
associate the first node with a second node of the address graph, the second node representing the identifying user information.

12. The non-transitory computer readable storage medium of claim 11, wherein the instructions to identify one or more addresses stored in the collateral generation system further comprises instructions that when executed by the processor causes the processor to:
traverse the address graph from the second node representing the received user identifying information to one or more nodes representing received addresses; and
identify the set of addresses associated with the one or more nodes and the graph distance between the second node representing the received user identifying information and each node representing a physical address of the set of physical addresses.

13. The non-transitory computer readable storage medium of claim 12, wherein the instructions to select a physical mailing address for the physical collateral from the identified one or more addresses further comprises instructions that when executed by the processor causes the processor to:
determine the graph distance between each node representing a physical address of the set of physical addresses and the second node representing the received user identifying information; and
select the address associated with the shortest graph distance as the physical mailing address.

14. The non-transitory computer readable storage medium of claim 10, wherein the instructions to identify one or more addresses stored in the collateral generation system further comprises instructions that when executed by the processor causes the processor to:
access a user profile associated with the identifying user information within the collateral generation system; and
retrieve one or more addresses stored in the user profile.

15. The non-transitory computer readable storage medium of claim 10, wherein the instructions to determine that the user should be sent physical collateral further comprises instructions that when executed by the processor causes the processor to select to be sent physical collateral based on targeting criteria associated with the collateral provider.

16. The non-transitory computer readable storage medium of claim 10, wherein the instructions to generate a file for specific physical collateral based on the user activity information and the rules associated with the collateral provider further comprises instructions that when executed by the processor causes the processor to assemble a creative template, creative elements, and the online user activity information associated with the identifying user information.

17. The non-transitory computer readable storage medium of claim 10, wherein the instructions to generate a file for specific physical collateral based on the user activity information and the rules associated with the collateral provider further comprises instructions that when executed by the processor causes the processor to verify the mailing address against the NCOA (National Change Of Address) database.

18. A system for generating and sending specific direct mail, the system comprising:
an information processing module configured to receive, from a collateral provider, online user activity information associated with identifying user information stored within a collateral generation system, the identifying user information associated with a user of the collateral provider;
a campaign management module configured to:
determine, based on the user activity information based and a set of rules associated with the collateral provider that the user should be sent physical collateral;
identify one or more addresses stored in the collateral generation system, each address of the set of addresses associated with the identifying user information;
select a physical mailing address for the physical collateral from the identified one or more addresses;
a collateral creation module configured to generate a file for specific physical collateral based on the user activity information and the rules associated with the collateral provider; and
a publisher bidding module configured to transmit the file for the specific physical collateral to a production device for generation of the specific physical collateral to provide for delivery to the physical mailing address.

19. The system of claim 18, wherein the information processing module is further configured to:
generate a first node representing the online user activity information within an address graph of the collateral generation system, the address graph comprising a plurality of nodes linked with edges; and
associate the first node with a second node of the address graph, the second node representing the identifying user information.

20. The method of claim 19, wherein the campaign management module is further configured to:
traverse the address graph from the second node representing the received user identifying information to one or more nodes representing received addresses; and
identify the set of addresses associated with the one or more nodes and the graph distance between the second node representing the received user identifying information and each node representing a physical address of the set of physical addresses.
